(19) United States
(12) Patent Application Publication
(10) Pub. No.: US 2004/0145866 A1
(43) Pub. Date: Jul. 29, 2004

(54) Ergonomic stylus for personal digital assistants

(76) Inventor: David Michael Lilenfeld, Atlanta, GA (US)

Correspondence Address: David M. Lilenfeld, Suite 305, 424 Lindbergh Drive, Atlanta, GA, 30305, US

(21) Appl. No.: 10/352,358

(22) Filed: Jan. 29, 2003

(51) Int. Cl. G06F 1/16

(52) U.S. Cl. 361/686

(57) ABSTRACT

An ergonomic stylus for computer touch-screen, including that used in personal digital assistants, with a body consisting of a tip and two or more arms. The arms reflexively assume a spread position when removed from the pen slot of a personal digital assistant to be gripped by the user and to provide the user with a hand position which is more relaxed and ergonomic than with styluses known in the art. When being replaced and being stored in the pen slot, the arms of current invention assume a pinched position so that the current invention fits within the limited confines of the pen slot.

### CROSS-REFERENCE TO RELATED APPLICATIONS

Not applicable.

### REFERENCE TO MICROFICHE APPENDIX

Not applicable.

### BACKGROUND OF INVENTION

1. Field of the Invention

The invention relates in general to a stylus for personal digital assistants, and more particularly to an ergonomic stylus which is convenient, comfortable and ergonomically superior than styluses known in the art.

2. Description of the Related Art

Today many people are in pursuit of high efficiency, causing them to change from conventional diaries to electronic diaries. Among the types of electronic diaries, the Personal Digital Assistant (PDA) is extremely popular. This is because the PDA is light-weight, easy to start, highly expandable and has a complete range of accessories allowing the users to install various software applications to meet their needs. Users can arrange schedules, search for contact information, browse outstanding appointments, take immediate memos, receive and send emails, and play games with the typical PDA.

FIG. 1a shows a three-dimensional block diagram of a conventional PDA. The PDA 100 in FIG. 1a includes a base unit 105, a display panel 110, control buttons 115. FIG. 1b shows a prior art stylus 120. The display panel 110 is located on the face 125 of the base unit 105. The display panel 110 can be a Liquid Crystal Display (LCD), while the control buttons 115 are located on the base unit's top face 125 for easy accessibility.

The prior art stylus 120 (FIG. 1b) slides into a pen slot 130 of the base unit 105 along with the direction of an arrow 135 shown in FIG. 1a, lest the stylus be misplaced. Users operate the PDA 100 by touching the stylus to the display panel 110 lightly. The pen slot 130 is very limited in size so that it can fit within the body of the PDA 100, which is commonly carried in persons' pockets, purses or briefcases.

The PDA 100 is currently used for many different tasks. Also, as PDA technology continues to develop, people will become more reliant on their PDA and will use their PDA to perform a greater number and a greater complexity of tasks. The current tasks, as well as the growing number of tasks, will require the user to spend a greater amount of time operating their PDA 100. The prior art stylus 108 known in the art are small enough to fit within the confines of the pen slot 130 but too small to be comfortable to hold in the hand for any length of time during operation of the PDA 100.

### BRIEF SUMMARY OF INVENTION

It is therefore an object of the invention to provide personal digital assistant users with a stylus which is ergonomic and comfortable during prolonged use while still being storable in the pen slot of existing PDAs.

### BRIEF DESCRIPTION OF THE FIGURES

FIG. 1a is a three-dimensional block diagram of a conventional PDA.

FIG. 1b shows a prior art stylus.

FIG. 2a is a front view of the ergonomic stylus in accordance with the current invention.

FIG. 2b is a cut-away front view of the ergonomic stylus while stored in a pen slot of a personal digital assistant.

FIG. 3 is a front view of one embodiment of the current invention showing three arms.

FIG. 4a is a view of the current invention being gripped by the digits of a user.

FIG. 4b is a view of the current invention being used by a digit of a user.

FIG. 5 is a view of the current invention being placed in the pen slot of a personal digital assistant by the user.

### DETAILED DESCRIPTION OF THE INVENTION

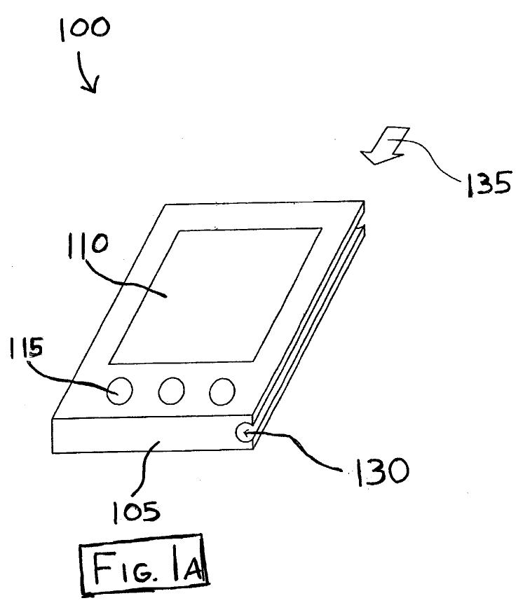

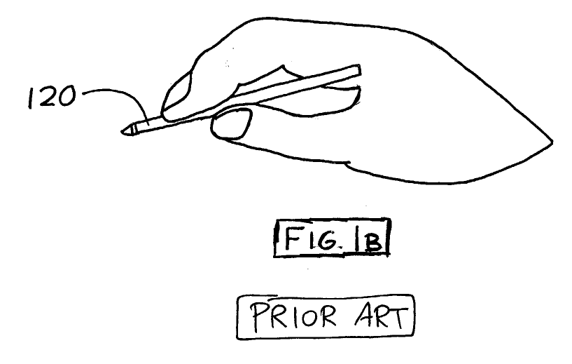

FIG. 1a shows a personal digital assistant 100 and FIG. 1b a prior art stylus 120 held in users hand.

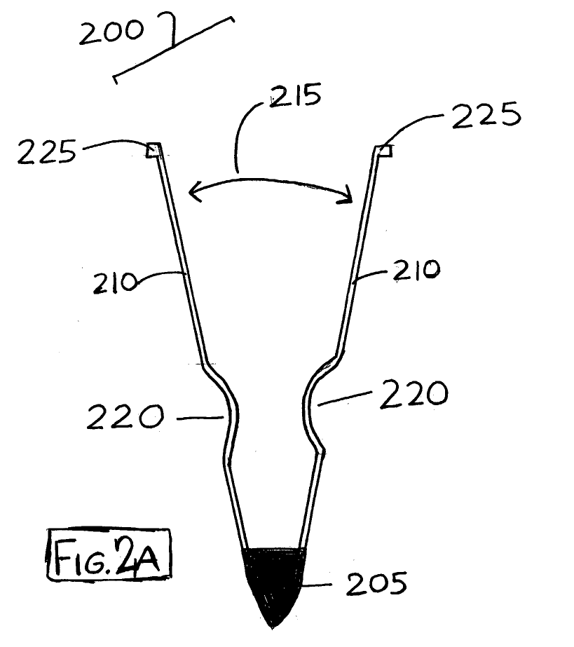

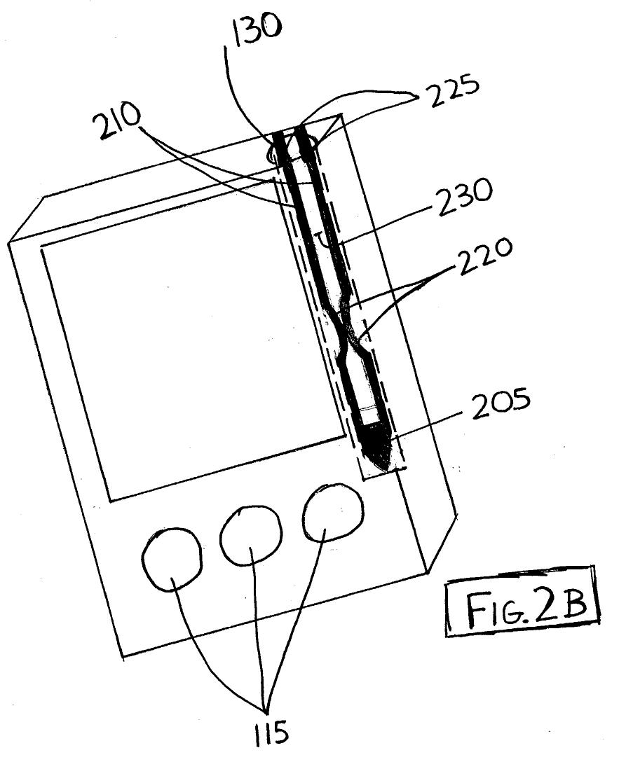

FIG. 2a shows a preferred embodiment of the current invention. In this embodiment, the ergonomic stylus 200 consists of a tip 205 and one or more arms 210 blended smoothly with, or joined to, the tip 205. The disposition and material of the arms 210 are such that when the ergonomic stylus 200 is removed from the pen slot 130, the arms 210 reflexively assume a natural spread position 215 (FIG. 1a). When in their natural spread position 215, the arms 210 make the current invention wider than the styluses known in the art 120 thereby providing a more natural and ergonomic gripping and holding position for the user's hand.

Also shown in FIG. 2a are arm phalanges 220, one or more of which may exist in a preferred embodiment of this invention. The phalanges 220 accommodate, comfort and assist the user's fingertips in gripping and holding the current invention during use. Also shown in FIG. 2a are end pieces 225 which prevent the current invention from passing too low in the pen slot 130 (FIG. 2b) and to provide a slight protrusion the user may grasp to remove the ergonomic stylus 200 from the pen slot 130. One or more end pieces 225 may be included in some embodiments of this invention.

FIG. 2b shows the same embodiment of the ergonomic stylus 200 shown in FIG. 2a, except that in FIG. 2b the ergonomic stylus 200 is shown while being stored in the pen slot 130. While being so stored, the arms 210 are in a pinched position 230 so that the ergonomic stylus 200 fits within the confines of the pen slot 130.

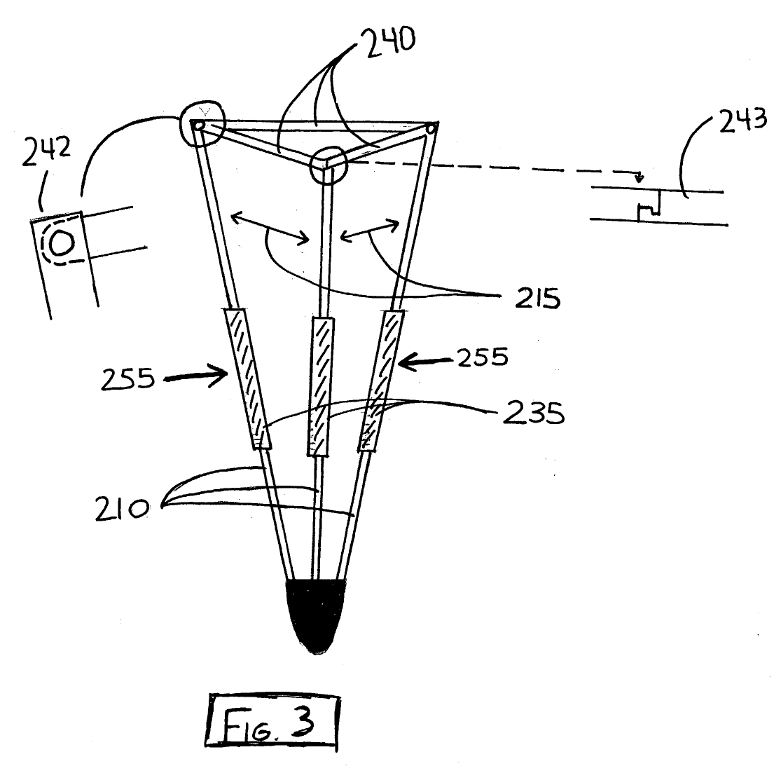

FIG. 3 shows an embodiment of the current invention with three arms 210 while in a natural spread position 215. More than three arms 210 may be included (not shown), although the arms 210 must be thin enough so that when in a pinched position 230, the ergonomic stylus 200 fits in the pen slot 130 (see FIG. 2b).

FIG. 3 also shows one or more grip pads 235 joined to the arms 210. The grip pads 235 add comfort and assist the user's fingertips while gripping and holding the ergonomic stylus 200. The grip pads 255 may be made of a variety of materials, including rubber, soft plastic or the like.

FIG. 3 further shows a stabilizer 240 and a means for attaching the stabilizer 243 to one or more arms 210. One such means is a hinge 242. The stabilizer 240 forces the arms 210 to maintain a spread position 215 even when inward pressure 255 is applied to the arms 210 by the user.

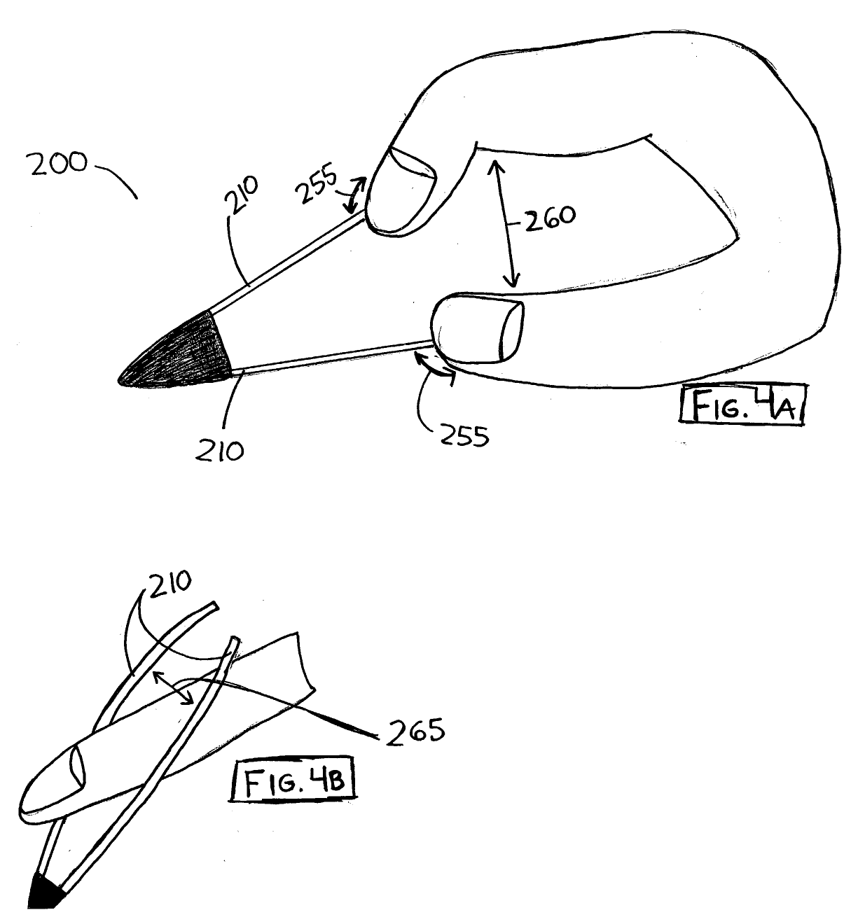

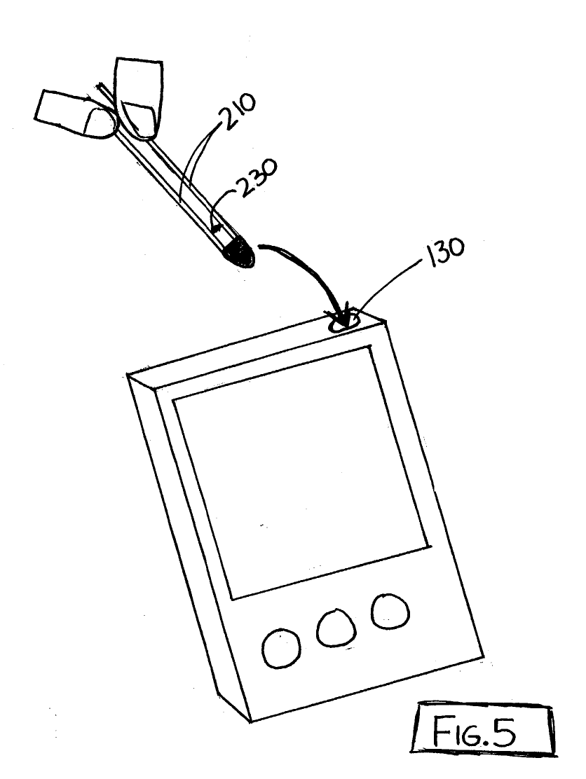

FIG. 4a shows one use of the ergonomic stylus 200. In FIG. 4a, the ergonomic stylus 200 is gripped by one or more fingers or the thumb (hereinafter collectively referred to as “digits”). When gripping the current invention, the user may apply varying degrees of inward pressure 255 to the outer sides of the arms 210. The arms 210 provide sufficient rigidity and natural spread 215 (FIG. 2a) so as to put and maintain the user's digits in a comfortable holding position 260, rather than in the clenched position as is required by styluses known in the art 120 (See FIG. 1b). The arms 210 are made of a material that allows the user to apply varying amounts of pressure easily with fingertips, but once the pressure is released, the arms 116 reflexively return to the spread position 215 (FIG. 2a). Such material may be a pliant metal, flexible plastic or the like. The result of the invention disclosed herein is a PDA stylus with a comfortable holding position 260 for the user's hand. This is ergonomically superior to the tightly clenched position required by styluses known in the art 120. (See FIG. 1b).

FIG. 4b shows another use of the current invention. In FIG. 4b, the user's digit is placed between the arms 210 thereby applying outward pressure 265 to the inner portions of the arms 210. Because of the rigidity of the arms 210, as disclosed above, the arms 210 will gently tighten against the user's digit, allowing the ergonomic stylus 200 to maintain this position without being held by the user and without being otherwise supported. Use of grip pads 235 (see FIG. 3) would provide additional friction to keep the current invention in the position shown in FIG. 4b. Using the ergonomic stylus 200 in this manner allows the user to enter data into the PDA 100 using just one finger and without having to hold the stylus. This allows for hands-free data entry into the PDA 100. The phalanges 220 (see FIG. 2) may assist in using the ergonomic stylus 200 in this manner by providing additionally resistance against the outward pressure 265 applied by the user's digit.

FIG. 5 shows the arms 210 of the ergonomic stylus 200 being put into a pinched position 230 by the user's digits so that the ergonomic stylus 200 can be placed and stored in the pen slot 130. Alternatively, the ergonomic stylus 200 can be stored in the pen slot 130 with the tip 205 first (not shown).

Those who are familiar with the skills and technology of the invention will understand that the invention is not limited to the disclosed embodiments. For instance, all or part of the ergonomic stylus 200 can be made in a variety of materials, the tip 205 can be made of a pliant material or fitted with a hinge, swivel or similar-mechanism so that its angle in relation to the body may be adjusted according to the user's preference. By way of further example, the ergonomic stylus 200, and each of its components can be of varying lengths, sizes and colors while still accomplishing the advantages described herein. Also, it is understood that one may find ways to hold or use the current invention to accomplish its ends in ways not expressly described herein.

According to the invention, a stylus for personal digital assistants is disclosed in the above-mentioned embodiments. Its design allows users to use the stylus for prolonged periods of time without having to maintain a clenched hand position as is necessary with the styluses known in the art 120. Such clenched positions can lead to various physical and neurological maladies, pain and discomfort. Thus, the users find the ergonomic stylus 200 disclosed herein to be more convenient, more comfortably and healthier because during use the digits of the hand are more relaxed than with styluses known in the art.

While the invention has been described by way of example and in terms of the preferred embodiments, it is to be understood that the invention is not limited to the disclosed embodiments. To the contrary, it is intended to cover various modifications and similar arrangements and procedures, and the scope of the appended claims therefore should be accorded the broadest interpretation so as to encompass all such modifications and similar arrangements and procedures.

It is also understood that the current invention may be used as a stylus for all computer touch-screens, and not just to touch-screens of PDAs. It is further understood that the current invention may be used with various types of writing units, such as fountain pens, fiber tip markers, pencils and the like.

What I claim as my invention:

1. A stylus for personal digital assistants comprising:
a body;
a tip on said body;
two or more arms on said body.

2. The device of claim 1, wherein said arms reflexively assume a spread position when removed from a pen slot of a personal digital assistant and maintain a pinched position when stored in said pen slot.

3. The device of claim 1, further comprising:
one or more phalanges.

4. The device of claim 1, further comprising:
one or more grip pads joined to said arms.

5. The device of claim 1, further comprising:
one or more stabilizers to assist said arms in maintaining a spread position when the stylus is removed from the pen slot.

6. The device of claim 5, further comprising:
a hinge to join each stabilizer to an arm and a mechanism for temporarily attaching the stabilizer to a second arm.

7. The device of claim 1, wherein the tip is made of a pliable material so that the angle can be adjusted according to the user's preference.

8. The device of claim 1, further comprising:
end pieces joined to the arms.
